(19) United States
(12) Patent Application Publication
(10) Pub. No.: US 2012/0030710 A1
(43) Pub. Date: Feb. 2, 2012

(54) TV WITH LANDLINE INTEGRATED INTO TV'S USER INTERFACE

(75) Inventor: ANDY NGUYEN, San Diego, CA (US)

(73) Assignee: SONY CORPORATION

(21) Appl. No.: 12/844,165

(22) Filed: Jul. 27, 2010

(51) Int. Cl. H04N 5/445; H04N 7/173

(52) U.S. Cl. 725/45; 725/106

(57) ABSTRACT

A landline telephone circuit is provided within a TV chassis or in a set-back box connectable to the TV processor to enable a user to place and receive calls through the TV. The telephone feature is integrated with the UI of the TV so that telephone features appear alongside other TV features. The telephone feature is controlled by the TV remote control, and has a microphone and computer storage for audio and database information.

### I. FIELD OF THE INVENTION

The present application relates generally to TVs with landlines integrated into the user interface (UI) of the TV.

### II. BACKGROUND OF THE INVENTION

Landline telephone remain important even with burgeoning wireless telephone use. Landlines often offer cheaper operational cost than wireless phones, and market shares for some telephony applications such as voice over Internet protocol (VoIP) and video conferencing remains relatively small for reasons of bandwidth. Thus, there is still a strong need for a dedicated landline telephone in meeting rooms, hotel rooms, and in the home.

As understood herein, when a person is watching TV such as in a motel room or other location, the phone can ring, requiring the person to rouse himself and locate the phone should the person desire to answer it. This can be distracting, annoying, and inconvenient.

### SUMMARY OF THE INVENTION

Present principles understand that by combining a television with a landline phone, ease of customer use is facilitated, the number of devices in a room is reduced, and interruptions to TV viewing are reduced because a person can answer or make a call without moving or leaving the TV.

Accordingly, a TV includes a TV processor, a TV tuner sending TV signals to the TV processor, and a video display controlled by the TV processor to display video in the TV signals. The TV also has one or more speakers controlled by the TV processor to present audio in the TV signals. The TV processor presents on the video display a user interface (UI) including a single row of genre selector elements and, when an element is highlighted or selected, a single column of selectable elements pertaining to a respective genre under a selected genre selector element. One of the genre selector elements is a TV selector element selectable to cause input to the video display and speaker to be from the TV tuner. A second genre selector element is a telephone selector element which, when highlighted or selected, causes a column of telephone-related elements to appear.

In some embodiments a telephone module is provided within a chassis of the TV or is housed separately therefrom and is connected to the TV processor. For example, the telephone module can be provided in a set back box housed separately from the chassis. The telephone module may communicate with the public switched telephone network (PSTN) over a landline and in example non-limiting embodiments may include a speaker and a microphone which receives voice signals and provides the signals to a TM controller processor. The TM controller processor controls a telephony circuit within the module and connected by a landline to the PSTN. As an example, the telephony circuit can include a full duplex voice path in the frequency range of 300 Hz to 3400 Hz, and circuitry providing for call progress tones.

In some embodiments, responsive to receiving a signal from the telephone module that a telephone is incoming, the TV processor presents a caller identification string on the video display indicating a telephone number of a calling party. The TV processor can also present on the display an “answer” selector element which may be selected by means of a TV remote control (RC) to cause the telephone module to answer the call at least in part by enabling voice input from a microphone. Furthermore, the TV processor can also present on the video display a “send to voice mail” selector element responsive to an incoming call. Responsive to selection of the “send to voice mail” selector element, the TV processor can command the telephone module to activate a voice mail feature of the telephone module, in which a caller's message is recorded. Responsive to selection of the “answer” selector element the TV processor can automatically mute the speaker and in response to selection of the “send to voice mail” selector element the TV processor does not mute the speaker. The “answer” selector element and the “send to voice mail” selector element may be presented on a currently presented screen including a live video screen responsive to an incoming call arriving, such that a viewer of the TV answers the call or causes it to be sent to voice mail with a single click of the RC.

In another aspect, a TV includes a TV processor, a TV tuner sending TV signals to the TV processor, and a video display controlled by the TV processor to display video in the TV signals. The TV also has one or more speakers controlled by the TV processor to present audio in the TV signals. The TV processor presents on the video display a user interface (UI) including a set of telephone-related elements. The elements include a “place call” selector element selectable to cause a sub-UI to appear on the display into which a user can enter, by means of a TV remote control (RC), a telephone number to call. A second element can be presented which is selectable to cause the TV processor to command a telephone module to dial a customer service telephone number prestored in the TV and being a customer service telephone number of a manufacturer of the TV. Yet a third element is presented and is selectable to enable a viewer to establish answering machine-related settings for the telephone module.

In another aspect, a method executed by a TV processor controlling a TV display and at least one TV audio speaker includes receiving a message that a telephone call is incoming. The method also includes, responsive to the message, presenting on the display “answer” and “voice mail” selector elements, and responsive to selection of the “answer” selector element, muting audio on the TV audio speaker while continuing to present video on the TV display and commanding a telephone module to pick up the call. However, responsive to selection of the “voice mail” selector element, the method includes commanding the telephone module to activate its voice mail feature and continuing to play both audio and video on the TV audio speaker and TV display, respectively.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles, schematically showing interior components of the TV;

FIGS. 2 and 3 are screen shots of an example user interface (UI) implemented as a cross-media bar (XMB) including a “telephone” category and showing items in the telephone category;

FIGS. 4-6 are screen shots of example sub-UIs that may be invoked from FIG. 2 or 3;

FIG. 7 is a flow chart of example logic executed by the TV for an incoming call; and

FIG. 8 is a flow chart of example logic executed by the TV for an outgoing call.

### DETAILED DESCRIPTION OF THE PREFERRED EMBODIMENT

Referring initially to FIG. 1, a TV system 10 includes TV chassis 12 holding a TV video display 14 and one or more audio speakers 15, both controlled by a TV processor 16 accessing a non-transitory computer readable storage medium or media 18, implemented as solid state storage, disk-based storage, etc. The TV processor 16 can receive TV signals from a TV tuner 20, typically located within the chassis 12 but in some implementations located in a separately housed set-top box. The TV processor 16 can receive wireless user command signals from a wireless remote control (RC) 22, typically in the infrared (IR) range but sometimes in the radiofrequency (RF) range. To this end, a wireless RC signal receiver 24 can be provided to receive signals from the RC 22 and send the signals to the processor 16.

According to present principles, a telephone module 26 may be provided within the chassis 12 or housed separately therefrom and connected to the TV processor 16. The telephone module 26 can include one or more speakers 28 such as telephone ringers and a microphone 30 which receives voice signals and provides the signals to a TM controller processor 32 accessing one or more non-transitory computer readable storage media 34. The controller processor 32 may be part of or otherwise control a telephony circuit 36 connected by a landline 38 such as a wire or fiber optics or microwave landline to the public switched telephone network (PSTN) 40. In any case, the controller processor 32 communicates with the TV processor 16.

Without limitation and by way of illustration the telephony circuit 36 may include a full duplex voice path in the frequency range of 300 Hz to 3400 Hz. The circuit 36 may include circuitry providing for call progress tones such as dial tones and ringing signals as well as provide for subscriber dialing and operator services. Furthermore, the circuit 36 may include battery feed, overvoltage protection, ringing, supervision, a codec, hybrid circuitry, and testing circuitry (collectively known as “BORSCHT”) that may be used in plain old telephone service (POTS) signaling, line supervision, and telephone terminal operation. All or parts of the circuit 36 can be implemented on a telecommunications network line card and can be integrated into a chipset.

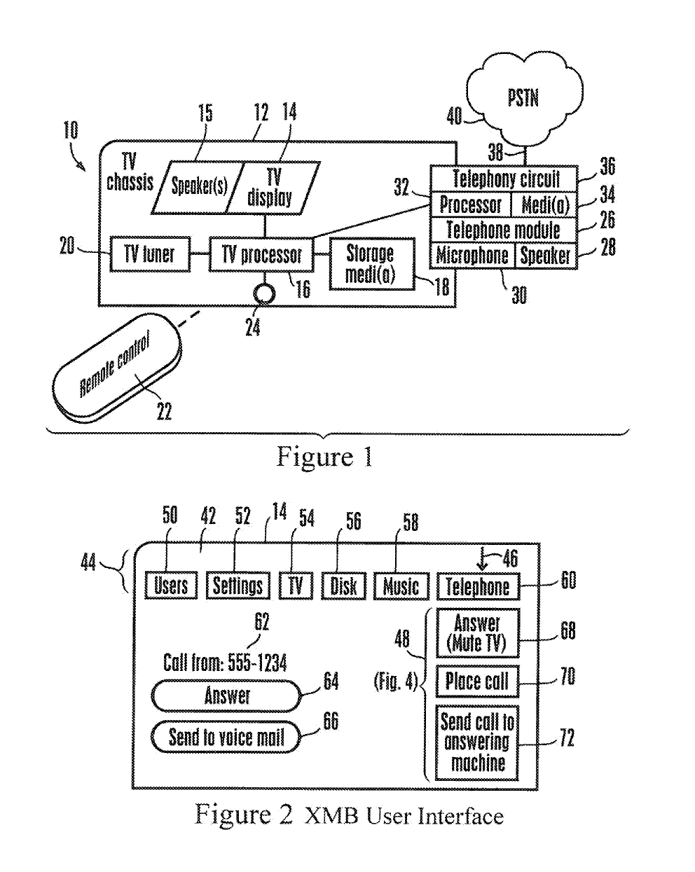

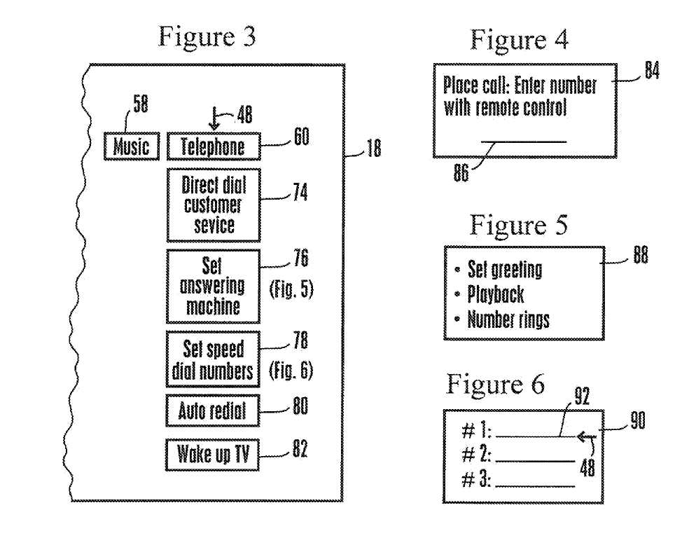

Now referring to FIGS. 2 and 3, in an example embodiment a user interface (UI) 42 is shown which includes a single row 44 of genre selector elements and, when an element is highlighted or selected as indicated by the screen cursor 46 controllable by the RC 22, a single column 48 of selectable elements pertaining to that genre under the selected genre selector element as shown. In the example shown in FIGS. 2 and 3, the genre selector elements in the row 44 may include, from left to tight, a users element 50 which can be selected to establish user accounts for each user of the TV. A settings selector element 52 may be provided which may be selected to establish TV settings, e.g., video display 14 settings, closed caption settings, and so on. Next, a TV selector element 54 may be provided to cause input to the display 14 and speakers 15 to be from the TV tuner 20, whereas a disk selector element 56 may be presented to cause the TV to present content from a disk in a video disk player. A music selector element 58 may also be presented to cause a music selection folder to be opened to allow music to be played on the speakers 15.

In accordance with present principles, a telephone selector element 60 may be provided in the row 44 of genre selectors which, when highlighted or selected as shown, causes a column 48 of telephone-related elements to appear below it. FIG. 2 shows some example telephone elements that may be presented while FIG. 3 shows additional example telephone elements that may be presented.

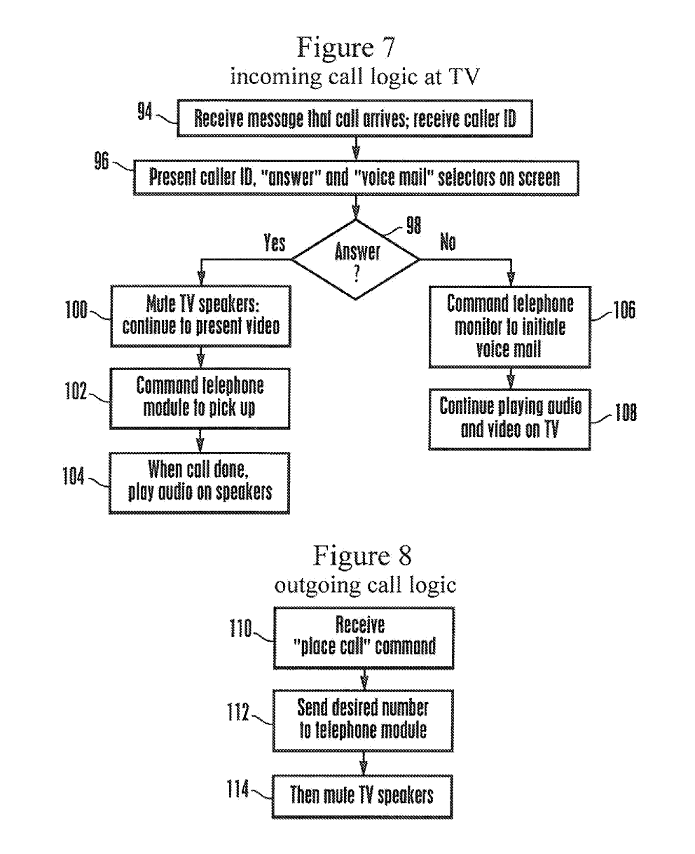

Prior to describing the functions of the telephone elements in the column 48 of telephone-related elements, attention is drawn to the left portion of FIG. 2. When an incoming call is received by the telephone module 26, the controller processor 32 informs the TV processor 16 of this fact and in accordance with logic shown in FIG. 7 and described further below, the TV processor 16 in response presents a caller identification string 62 on the display 14 as shown, indicating the telephone number of the calling party. Also, in the example shown the TV processor 16 presents on the display 14 an “answer” selector element 64 which may be selected by means of navigating the screen cursor 46 using the RC 22 to the answer selector element 64 and pressing a “select” key on the RC 22. In response, the TV processor 16 commands the controller processor 32 to pick up, or answer, the call. On the other hand, the TV processor 16 also presents a “send to voice mail” selector element 66 on the display 14 when an incoming call is present and responsive to selection of the “send to voice mail” selector element 66, the TV processor 16 commands the controller processor 32 to activate the voice mail feature of the telephone module 26, in which a caller's message may be recorded on, e.g., the telephone module storage media 34.

It is to be understood that while FIG. 2 shows the elements 62, 64, 66 presented on the UI 42 screen, the elements 62, 64, 66 can be presented on any currently presented screen including a live video screen whenever an incoming call arrives. For example, the elements 62, 64, 66 can be presented in a graphics plane of the TV and overlaid on a video plane in which TV programming is being presented so that regardless of what screen the user has invoked, the elements 62, 64, 66 can appear to enable a viewer of the TV to answer the call or cause it to be sent to voice mail with a single click of the RC 22.

Turning attention to the telephone elements in the column 48 of telephone-related elements, an “answer” element 68 may be presented indicating that if selected, the TV audio will be muted. Selection of the “answer” element 68 results in the same response as selection of the “answer” selector element 64 mentioned above and described in detail below, it being understood that the “answer” element 68 in the 48 of telephone-related elements is presented only when the UI 42 is selected for display and the telephone selector 60 is active.

Also, a “place call” selector element 70 can be presented in the column 48 as shown to enable a viewer of the TV to place a call through the telephone module 26 using the RC 22. FIGS. 4 and 8, described further below, illustrate example operation of the TV processor 16 responsive to selection of the “place call” selector element 70.

In addition, a “send call to answering machine” element 72 may be presented which, when selected, causes the TV processor 16 to function as described above with respect to the “send to voice mail” selector element 66.

FIG. 3 shows additional elements that may be presented in the column 48. As shown, an element 74 may be selected, responsive to which the TV processor 16 commands the telephone module 26 to dial a telephone number typically prestored in the TV and being the customer service telephone number of the manufacturer of the TV. The prestored customer service number is provided by the TV to the telephone module 26.

An element 76 in the row 48 may be selected to enable a viewer to establish certain answering machine-related settings for the telephone module 26. FIG. 5, described below, further illustrates an example response to selection of the element 76. Also, an element 78 may be provided to enable a user to input speed dial numbers as further described in reference to FIG. 6, while an “auto redial” selector element 80 may be provided which can be selected to cause the TV processor 16 to command the telephone module 26 to redial the last number it dialed. A wake up TV selector element 82 can be provided to invoke a sub-UI permitting the viewer to establish a wake up time at which the TV will automatically turn on, as well as a sleep time at which the TV will automatically power down.

As mentioned above, responsive to selection of the “place call” element 70, the TV processor 16 presents on the display 14 a UI 84 which includes a field 86 into which a user may type a telephone number to be called using the number keys on the RC 22. The UI 84 may also include a prompt as shown instructing the user to place a call by entering a number using the RC and then pressing a “select” or “enter” key on the RC 22.

As also mentioned above, responsive to selection of the “set answering machine” element 76, an example UI 88 shown in FIG. 5 may be presented on the TV display 14. Among other things a user can select to set a greeting for the voice mail feature of the telephone module 26 to play responsive to an incoming call being sent to voice mail. When this is selected the TV processor 16 commands the controller processor 32 to record, as the answering machine greeting, the next sounds it receives from the microphone 30 of the module 26. The user may also select from the UI 88 to playback messages recorded on the telephone module 26, in which case the TV processor 16 commands the controller processor 32 to play, on the telephone module speakers 28, messages recorded on the module media 34. Other voice mail features may also be input using the UI 88 to the TV processor 16 and sent from there to the controller processor 32 for execution, such as the number of rings to use prior to invoking the answering machine feature of the telephone module 26, etc.

Turning to FIG. 6, responsive to selection of the “set speed dial numbers” element 78, a UI 90 may be presented with fields 92, numbered in ascending order as shown, into which a user may enter telephone numbers using the RC 22. The TV processor 16 correlates the numbers entered into the fields 92 with their numeric position in the ascending order. Thereafter, the user may dial a speed dial number by selecting the “place call” element 70 and then entering into the field 86 of the UI 84 shown in FIG. 4 the numeric position, e.g., “1” or “2”, of the desired speed dial number, and then pressing a “select” key on the RC 22. The TV processor 16 interprets entry of a single number as a speed dial number, looks up the corresponding telephone number that was entered using the UI 90 in FIG. 6, and then commands the telephone module 26 to place a call to the corresponding number in accordance with logic described further below in reference to FIG. 8.

Other elements may appear in the column 48. By way of non-limiting example, similar to the customer service element 74, a concierge telephone number-dialing element may be presented which, when selected, dials a prestored concierge number.

Now referring to FIG. 7 for an understanding of example logic that may be implemented by the TV processor 16 when an incoming call is received, at block 94 a message is received from the controller processor 32 of the telephone module 26 that an incoming call has arrived, along with the caller ID of the calling number. At block 96 the caller ID is presented on the display 14 as described above, along with the “answer” and “voice mail” selector elements 64, 66. Decision diamond 98 indicates that responsive to a user selection of “answer”, the TV processor 16 mutes the audio on the TV speakers 15 at block 100, continuing to present video on the display 14 from whatever source had been currently active when the call arrived. At block 102 the TV processor 16 commands the controller processor 32 to pick up the call, activating the microphone 30 of the telephone module 26. When the telephone module 26 informs the TV processor 16 that the call has concluded, audio from the current source is presented on the TV speakers 15, i.e., the speakers 15 are no longer muted, at block 104.

On the other hand, responsive to the user selecting “voice mail” 66 and also as a default to the user not selecting anything within a predetermined period (e.g., ten seconds) after a call arrives, the logic flows from decision diamond 98 to block 106 to command the telephone module 26 to activate its voice mail feature. Both audio and video continue to be played on the speakers 15/display 14 at block 108 under these circumstances.

FIG. 7 shows example logic for placing a call. Commencing at block 110 a place call command is received from, e.g., the RC 22 operating on the U184 of FIG. 4 or selecting the customer service element 74 of FIG. 3. The desired telephone number is sent to the telephone module 26 at block 112 with a command to dial the number and activate the microphone 30. After the command is sent, the TV speakers 15 are muted at block 114, there being no reason to mute them prior to sending the dial command.

The telephone module 26 may also be used as a dial-up modem. The modem would not be ideal for large internet usage, but could be good for metadata such as weather, time, movie/show listing.

Other features of the telephone module 32 may include a contact telephone book, which may be invoked from a selector element provided under the telephone element 60.

While the particular TV WITH LANDLINE INTEGRATED INTO TV'S USER INTERFACE is herein shown and described in detail, it is to be understood that the subject matter which is encompassed by the present invention is limited only by the claims.

What is claimed is:

1. TV comprising:
TV processor;
TV tuner sending TV signals to the TV processor;
video display controlled by the TV processor to display video in the TV signals;
speaker controlled by the TV processor to present audio in the TV signals; wherein the TV processor presents on the video display a user interface (UI) including a single row of genre selector elements and, when an element is highlighted or selected, a single column of selectable elements pertaining to a respective genre under a selected genre selector element, at least one genre selector element being a TV selector element selectable to cause input to the video display and speaker to be from the TV tuner, at least a second genre selector element being a telephone selector element which, when highlighted or selected, causes a column of telephone-related elements to appear.

2. The TV of claim 1, comprising a telephone module provided within a chassis of the TV or housed separately therefrom and connected to the TV processor, the telephone module communicating with the public switched telephone network (PSTN) over a landline.

3. The TV of claim 2, wherein the telephone module is provided in a set back box housed separately from the chassis.

4. The TV of claim 2, wherein the telephone module is provided in the chassis.

5. The TV of claim 2, wherein the telephone module includes at least one speaker and a microphone which receives voice signals and provides the signals to a TM controller processor, the controller processor controlling a telephony circuit connected by a landline to the PSTN.

6. The TV of claim 5, wherein the telephony circuit includes a full duplex voice path in the frequency range of 300 Hz to 3400 Hz, and circuitry providing for call progress tones.

7. The TV of claim 2, wherein responsive to receiving a signal from the telephone module that a telephone is incoming, the TV processor in response presents a caller identification string on the video display indicating a telephone number of a calling party, the TV processor also presenting on the display an “answer” selector element which may be selected by means of a TV remote control (RC) to cause the telephone module to answer the call at least in part by enabling voice input from a microphone.

8. The TV of claim 7, wherein the TV processor also presents on the video display a “send to voice mail” selector element responsive to an incoming call and responsive to selection of the “send to voice mail” selector element, the TV processor commands the telephone module to activate a voice mail feature of the telephone module, in which a caller's message is recorded.

9. The TV of claim 8, wherein responsive to selection of the “answer” selector element the TV processor automatically mutes the speaker and in response to selection of the “send to voice mail” selector element the TV processor does not mute the speaker.

10. The TV of claim 8, wherein the “answer” selector element and the “send to voice mail” selector element are presented on a currently presented screen including a live video screen responsive to an incoming call arriving, such that a viewer of the TV answers the call or causes it to be sent to voice mail with a single click of the RC.

11. TV comprising:
TV processor;
TV tuner sending TV signals to the TV processor;
video display controlled by the TV processor to display video in the TV signals;
speaker controlled by the TV processor to present audio in the TV signals;
wherein the TV processor presents on the video display a user interface (UI) including a set of telephone-related elements, the elements including:
a “place call” selector element selectable to cause a sub-UI to appear on the display into which a user can enter, by means of a TV remote control (RC), a telephone number to call;
an element selectable to cause the TV processor to command a telephone module to dial a customer service telephone number prestored in the TV and being a customer service telephone number of a manufacturer of the TV; and
an element selectable to enable a viewer to establish answering machine-related settings for the telephone module.

12. The TV of claim 11, wherein the elements further include an element selectable to enable a user to input speed dial numbers.

13. The TV of claim 11, wherein the elements further include an “auto redial” selector element selectable to cause the TV processor to command the telephone module to redial a last number it dialed.

14. The TV of claim 11, wherein the elements further include a “send call to answering machine” element selectable to cause the TV processor to command the telephone module to send an incoming call to voice mail for recoding.

15. The TV of claim 11, wherein responsive to selection of the element selectable to enable a viewer to establish answering machine-related settings for the telephone module, the TV processor presents on the display a UI enabling a user to establish a greeting for a voice mail feature of the telephone module and to play back messages recorded on the telephone module, in which case the TV processor commands the telephone module to play messages recorded on the telephone module.

16. Method executed by a TV processor controlling a TV display and at least one TV audio speaker, comprising:
receiving a message that a telephone call is incoming;
responsive to the message, presenting on the display “answer” and “voice mail” selector elements;
responsive to selection of the “answer” selector element, muting audio on the TV audio speaker while continuing to present video on the TV display and commanding a telephone module to pick up the call;
responsive to selection of the “voice mail” selector element, commanding the telephone module to activate its voice mail feature and continuing to play both audio and video on the TV audio speaker and TV display, respectively.

17. The method of claim 16, wherein the processor commands the telephone module to activate its voice mail feature and continues to play both audio and video on the TV audio speaker and TV display, respectively responsive to receiving no selection from a user within a predetermined period after receiving a message that a telephone call is incoming.

18. The method of claim 16, wherein responsive to the telephone module informing the TV processor that a call has concluded, the TV processor automatically resumes playing audio on the TV audio speaker.

19. The method of claim 16, comprising presenting on the TV display a caller ID of the incoming call.

20. The method of claim 16, wherein the incoming call is over a landline.
